(19) United States
(12) Patent Application Publication
(10) Pub. No.: US 2006/0010848 A1
(43) Pub. Date: Jan. 19, 2006

(54) Broom and rake tool

(76) Inventor: David Vosbikian, Moorestown, NJ (US)

Correspondence Address: Hollstein Keating Cattell Johnson & Goldstein P.C.;Willow Ridge Executive Office Park, Suite 301, 750 Route 73 South, Marlton, NJ, 08053, US

(21) Appl. No.: 10/892,710

(22) Filed: Jul. 16, 2004

(51) Int. Cl. A01D 7/00

(52) U.S. Cl. 56/400.04

(57) ABSTRACT

A manual hand tool combines the features of a pushbroom and a rake in a unique configuration. The tool's handle is connected substantially at the center of a pushbroom head from which bristles downwardly extend. A notch in the upper surface of the pushbroom is configured to receive rake tines which extend outwardly and forwardly from the broom head.

### BACKGROUND OF THE INVENTION

Over the years, there have been several attempts to combine, into a single hand tool, the cleaning and sweeping benefits of a pushbroom with the unique gardening effects of a rake. Representative examples of these attempts are found in U.S. Pat. No. 3,084,498, U.S. Pat. No. 4,741,149, and U.S. Pat. No. 6,032,447. However, the design and configuration of such tools fail to effectively and efficiently accomplish the desired pushbroom and raking functions. Additionally, such tools are awkward or difficult to use and their designs cause the broom sweeping function to interfere with the raking function and visa versa. To date, there has been no manual hand tool configured to be efficiently and effectively used both for broom sweeping and raking functions.

### SUMMARY OF THE INVENTION

It is thus an object of the present invention to provide a manual hand tool combining the features of a pushbroom and a rake which overcomes the limitations and disadvantages of prior tools.

It is an object of the present invention to provide a manual hand tool which effectively incorporates a pushbroom component and a rake component.

It is a further object of the present invention to provide a manual hand tool which can effectively and efficiently be used both as a pushbroom and as a rake.

It is still a further object of the present invention to provide a manual tool having pushbroom and rake functions which do not interfere with each other, as the tool is used for each function.

It is another object of the present invention to provide a manual tool which will remain sturdy and in tact during prolonged periods of usage.

It is a further object of the present invention to provide a manual tool which is readily and easily used in both the sweeping and raking functions and which allows the user to easily switch between functions.

These and other objects are accomplished by the present invention, a manual hand tool which combines the features of a pushbroom and a rake in a unique configuration. The tool's handle is connected substantially at the center of a pushbroom head from which bristles downwardly extend. A notch in the upper surface of the pushbroom is configured to receive rake tines which extend outwardly and forwardly from the broom head.

Novel features which are considered as characteristic of the invention are set forth in particular in the appended claims. The invention, itself, however, both as to its design, construction and use, together with the additional features and advantages thereof, are best understood upon review of the following detailed description with reference to the accompanying drawings.

### BRIEF DESCRIPTION OF THE DRAWINGS

FIG. 1 shows a perspective view of the manual hand tool of the present invention.

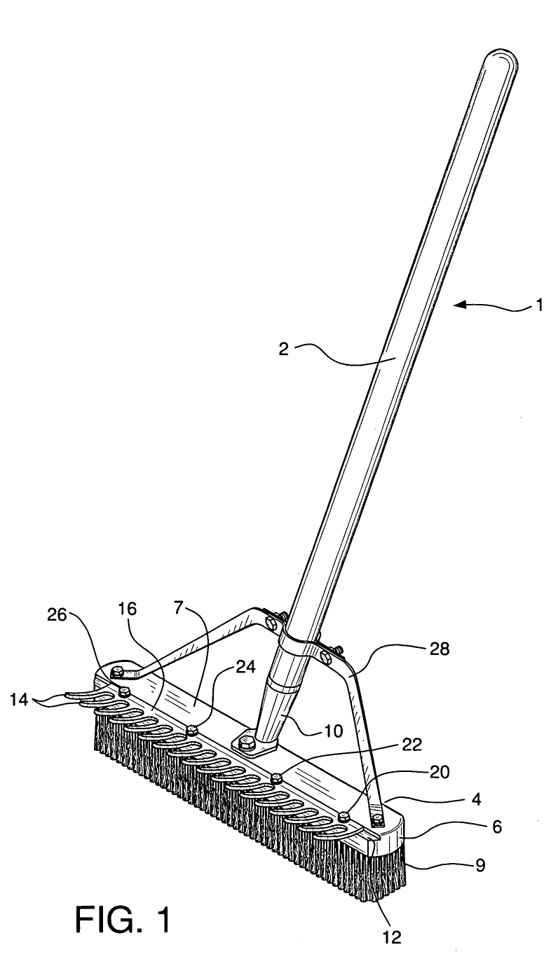

FIG. 2 shows the front view of the manual hand tool of the present invention.

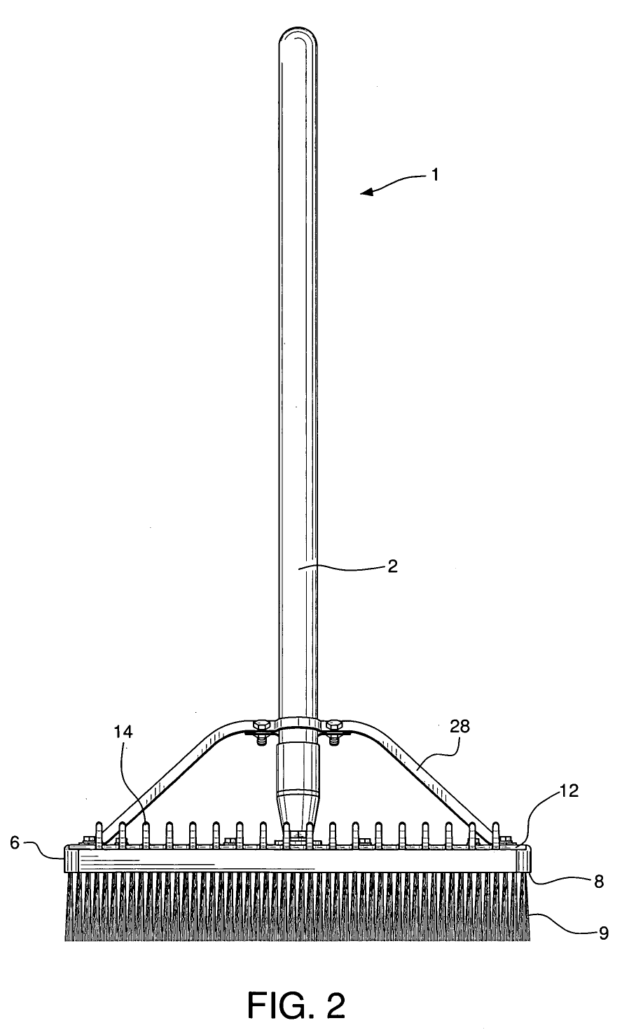

FIG. 3 shows the rear view of the manual hand tool of the present invention.

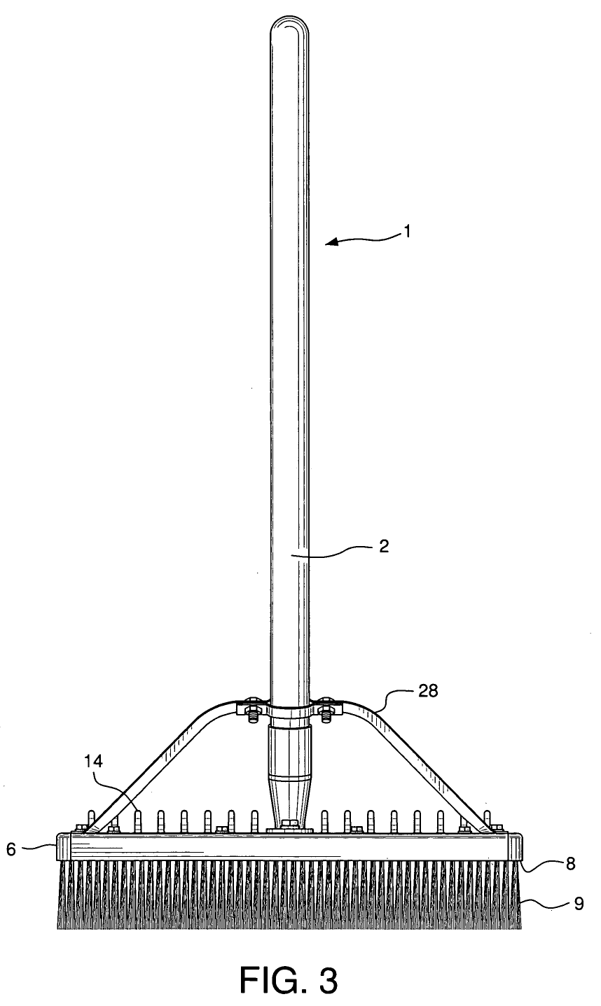

FIG. 4 shows the elevation view of the manual hand the tool of the present invention.

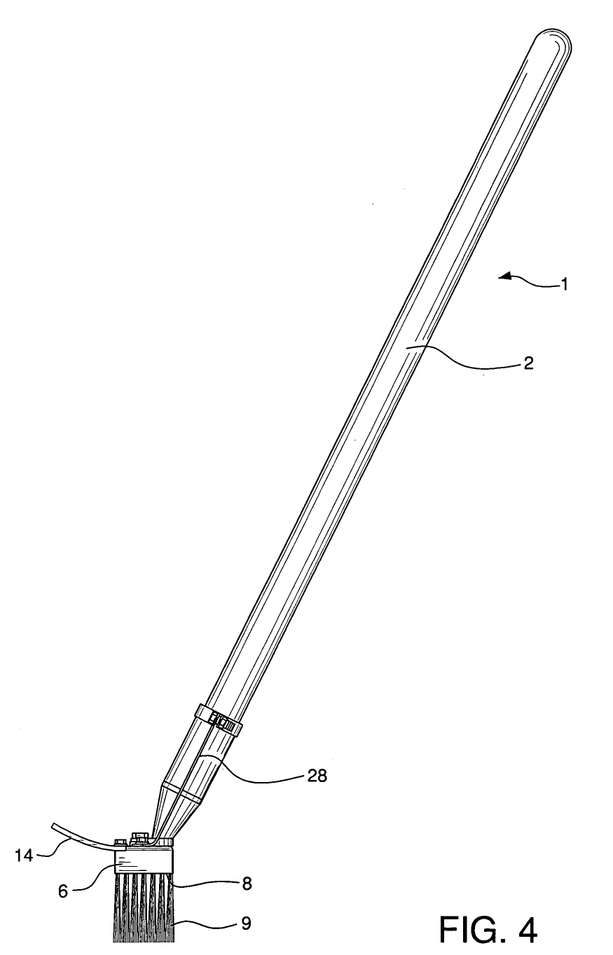

FIG. 5 shows the bottom view of the manual hand tool of the present invention.

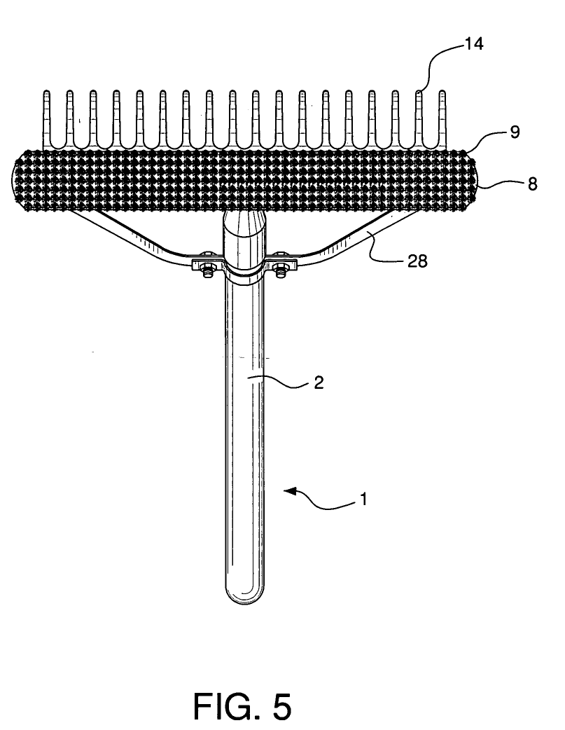

FIG. 6 shows the top view of the manual hand tool of the present invention.

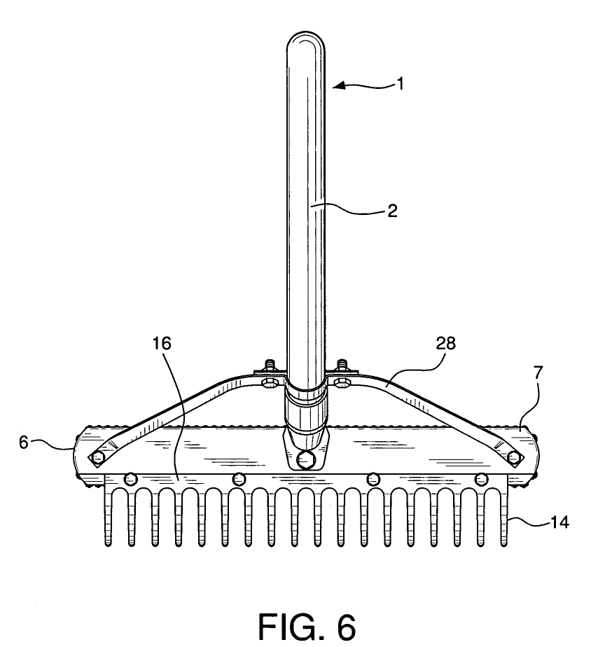

### DETAILED DESCRIPTION OF THE INVENTION

Tool 1 comprises elongated handle 2 which is secured to pushbroom head 4. Head 4 comprises broom support base 6 with top surface 7, bottom surface 8 and bristles 9 extending downwardly from bottom surface 8. Handle 2 is secured to top surface 7 of base 6 substantially at its center via connector 10. Alternatively, handle 2 may be connected, threadably or otherwise, directly to base 6.

At the forwardmost edge of top surface 7 and running substantially the full length of base 6 is notch 12. Secured within notch 12 are rake tines 14, extending outwardly and forwardly of head 4. The embodiment disclosed herein discloses integral rake support member 16 with tines 14. Support member 16 is secured within notch 12 by bolts 20, 22, 24 and 26. Alternatively, it is contemplated that tines 14 can each be a separate component and each can be individually secured within notch 12.

Triangular shaped bracket 28 provides a further rigid connection between handle 2 and head 4, and the necessary rigid support to ensure that handle 2 remains in place whether tool 1 is being used in the pushbroom function or the raking function.

It thus can be seen that tool 1 of the present invention can be efficiently and effectively be used as a pushbroom without interference or encumbrance from raking tines 14. Tool 1 can then be turned over and efficiently and effectively be used for raking without interference or encumberance from bristles 9.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A manual hand tool comprising:
a. a pushbroom head comprising a pushbroom support base, said pushbroom support base comprising a unitary, block-like base member having a top surface and a bottom surface, and pushbroom bristle means for sweeping functions, said bristle means extending from the bottom surface of the base member;
b. an elongated handle connected substantially at the center of the top surface of the base member; and
c. a plurality of rake tines positioned and secured directly on the top surface of the base member, each said tine extending directly from the top surface of the base member, outwardly from and forwardly of the pushbroom head.

2. The manual hand tool as in claim 1 further comprising a support bracket secured to the top surface of the base member, substantially near the ends of the base member, said bracket extending upwardly towards and secured directly to the handle.

3. The manual hand tool as in claim 1 further comprising a notch located within the top surface of the base member and extending substantially the length of the top surface, the tines being secured within the notch.
